(19) United States
(12) Patent Application Publication
(10) Pub. No.: US 2016/0267472 A1
(43) Pub. Date: Sep. 15, 2016

(54) SECURING DIGITAL GIFT CARDS WITH A PUBLIC LEDGER

(71) Applicant: Gyft, Inc., Redwood City, CA (US)

(72) Inventors: Vinodan K. Lingham, Los Altos, CA (US); Mark Levitt, Foster City, CA (US); Krisan Ramesh Nichani, San Francisco, CA (US); Guillaume P. Lebleu, San Francisco, CA (US)

(21) Appl. No.: 14/737,135

(22) Filed: Jun. 11, 2015

Related U.S. Application Data
(63) Continuation-in-part of application No. 14/658,097, filed on Mar. 13, 2015.
(60) Provisional application No. 62/133,244, filed on Mar. 13, 2015.

(51) Int. Cl. G06Q 20/36; G06Q 20/06

(52) U.S. Cl. CPC G06Q 20/3672; G06Q 20/3676; G06Q 20/3678; G06Q 20/065

(57) ABSTRACT

Disclosed herein is a method and system for standardizing a plurality of digital wallet credits into one digital wallet system. Expenditures of merchant-issued credit stored in digital wallets are supported by tokenization of assets. Assets are encoded and represented by currencies tracked on public ledgers. Data is mined from the public ledger, decoded, and presented to users with a unified interface which allows users to view balances at any time of all digital wallets in their possession.

### CLAIM FOR PRIORITY

This application is a continuation-in-part of U.S. Non-Provisional patent application Ser. No. 14/658,097, entitled “SYSTEM AND METHOD FOR ESTABLISHING A PUBLIC LEDGER FOR GIFT CARD TRANSACTIONS” and filed Mar. 13, 2015, and claims priority to U.S. Provisional Patent Application No. 62/133,244, entitled “SYSTEM AND METHOD FOR SECURING DIGITAL GIFT CARDS WITH A PUBLIC LEDGER” and filed Mar. 13, 2015. The contents of the above-identified applications are incorporated herein by reference in their entirety.

### TECHNICAL FIELD

The present invention relates to the tracking and recording of transfers of digital assets. More specifically, the present invention relates to retaining public records of gift card purchases and transfers.

### BACKGROUND OF INVENTION

A gift card is a digital asset which has value associated with a single business or group of businesses. Digital gift cards are prone to fraud as they rely on trusting multiple parties to safeguard the secret gift card codes. The goal of this invention is to provide a secure, compliant and portable way to mint, issue, transfer, and redeem digital gift cards.

### SUMMARY OF THE PRESENT INVENTION

Embodiments include a method for minting digital gift cards on a secure public ledger such as Bitcoin, in such a way that relevant regulations and issuers' policies are fully enforced. For instance, the method can be used to enforce the closed-loop movement of funds (funds can only be used only for goods or services in transactions involving a defined merchant or set of locations), or to limit the daily reload amount, or to prevent person-to-person transfer of funds. Such capabilities are key criteria for an issuer to be exempt from regulations such as the United States include FinCEN “prepaid access” rule.

Embodiments also include a method for supporting a variety of assets for each gift card, each asset with its own enforceable terms and rules, and a combination of assets. For instance, a single gift card may combine two assets: prepaid credits that never expire and bonus credits that expire on a certain date.

Embodiments also include a method for transferring a digital gift card into a customer wallet, for instance upon purchase by a customer.

Embodiments also include a method for preventing fraudulent transfer of a digital gift card's value through the use of short-lived tokens delivered in the customer wallet instead of the traditional static serial numbers and PINs. This method is designed such that secure digital gift cards can be used at brick-and-mortar and online merchants with existing points of sale (POS) systems, including brick-and-mortar POS systems where the gift card's serial number is typed, scanned (barcoded) or swiped (magnetic stripe), and online shopping carts of e-commerce companies.

Embodiments also include a system and method for uploading digital gift cards to a variety of wallet apps, such as Gyft Wallet® or Google Wallet®, and provide users with a consistent experience in those apps, for instance being able to check real-time balance for any card or send a card easily and quickly from one wallet app to another.

Embodiments also include a method for converting traditional plastic and paper gift cards, whose serial number and PIN are inherently static, into digital gift cards secured by a public ledger.

### BRIEF DESCRIPTION OF THE FIGURES

FIG. 1 is an illustrative example of tokenization of digital wallets, according to various embodiments;

FIG. 2 is a time flow chart for transactions using tokenized digital wallets, according to various embodiments;

FIG. 3 is a block diagram illustrating a method for encoding gift card assets of a digital wallet on a public ledger, according to various embodiments;

FIG. 4 is an embodiment of an authorization scheme, according to various embodiments;

FIG. 5 is a derivation chart for public keys, according to various embodiments;

FIG. 6 is a block diagram flow chart of the redemption of tokenized existing gift cards, according to various embodiments; and

FIG. 7 is a transaction diagram using dust amounts to encode data to a public ledger, according to various embodiments.

### DETAILED DESCRIPTION

Gift cards are merchant-specific value issued in the form of a public serial number and oftentimes issued together with a concealed PIN. Gift cards have traditionally been issued with the serial number encoded on the magnetic stripe of a plastic card or as a barcode-encoded serial number on a plastic or paper card. Increasingly, gift cards are being uploaded or directly bought on websites and mobile apps like the Gyft mobile Application®, where gift cards only exist as digital representations. Such gift cards are called virtual gift cards or digital gift cards. For purposes of this disclosure, the term “gift card” includes virtual or digital gift cards.

Gift cards traditionally represent one asset, a prepaid asset, but digital gift cards increasingly represent more than one asset at a time, each with different terms and compliance requirements. For instance, a buyer may have purchased an offer to buy $100 worth of credits at a business for $90 in cash, with the extra $10 expiring after a certain date, while the $90 prepaid never expire.

Gift card PINs are not required at redemption, and because they use static serial numbers that are not concealed, gift cards are fraught with fraud. Serial numbers printed on paper or plastic gift cards may get compromised at any time between their minting and the purchase by the customer, for instance by unscrupulous employees of companies issuing, re-selling or retailing the serial numbers. This lack of security is hampering the wider adoption of gift cards in general, and of digital gift cards especially, as a payment mechanism.

Digital gift cards are also not securely transferable from one digital wallet to another. Security relies on the receiver trusting the gift card wallet provider to not allow transfer if the secret code has been revealed to the customer. This lack of portability is limiting competition, increasing transaction costs on secondary markets, or making resale impractical, and ultimately reducing the value of digital gift cards to consumers.

Digital gift cards are also very fragmented in terms of how they are purchased, authenticated, balance-checked, cancelled, re-gifted or redeemed. Different gift card issuers offer different computer programming interfaces for applications to perform actions on the digital gift cards, resulting in high development costs of digital gift card applications, lack of consistency in user experiences, and ultimately a reduction of digital gift cards' potential as a payment mechanism. For instance, a gift card issuer might offer a computer programming interface to check a digital gift card balance, while another issuer might not.

Digital gift cards are regulated in the U.S. by the Prepaid Access rule. Fraud monitoring and ensuring compliance are difficult since there is no central record of transactions that investigators can use to trace movements of funds.

Secure public ledgers are ledgers recording the minting, transfer and redemption of digital assets. Public ledgers are maintained by a large number of distributed computers called miners. They offer a high level of security against unauthorized spend and against double-spend of digital assets through the use of public-key cryptography, decentralized record-keeping and decentralized consensus. They also provide a high level of traceability of funds movements to facilitate fraud detection, prevention and resolution, to the extent that the identity of account holders is known. The most popular example of a secure public ledger is Bitcoin®, but many other public ledger implementations exist.

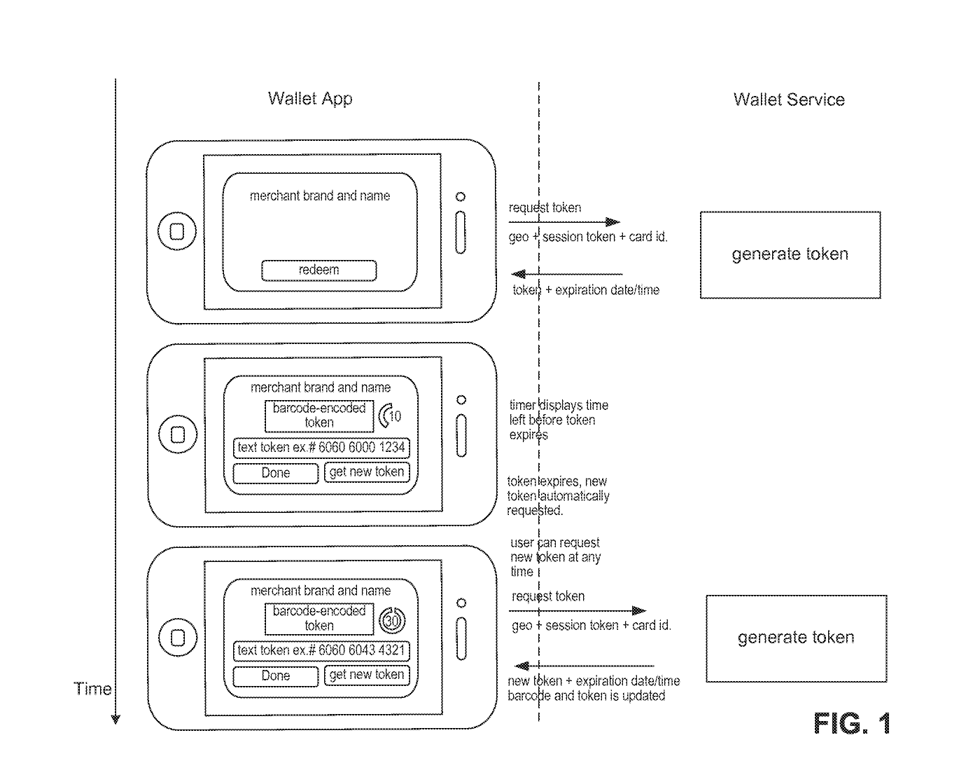

FIG. 1 is an example of tokenization of digital wallets, according to various embodiments. When the cardholder wants to conduct a transaction, the cardholder opens the wallet app, authenticates his identity with a username/password or other secure authentication mechanism, and selects the card. The cardholder then taps the word redeem. At that moment, the wallet app contacts the wallet service with the authentication token and requests a short-lived card token. The card token is a 19-digit number, although other numbers of digits may be acceptable depending on the point-of-sale system and network.

Upon verification of the authentication token, the wallet service returns a card token with an expiration date/time. This expiration date/time can vary among wallet service providers but typically lasts long enough to present the device to be scanned, typed in or read by a contactless device at the point of sale. If the card token expires while the cardholder is presenting the token at the point of sale, the wallet will automatically request a new card token. The cardholder or person holding the device can also request a new token at any time by selecting a button on the wallet application screen. The wallet application displays a timer showing how long the card token will remain valid.

An alternative to the online card token generation process is an offline Time-based One-Time Passcode/Token (TOTP) using the standard RFC 6238. The present invention proposes the use of a 19-digit standard card number (ISO/IEC 7812) that includes a 6-digit TOTP to secure access to digital assets organized as cards in a wallet. A ISO/IEC 7812 compliant 19 digit can be derived from the passcode as follows by concatenating the 6-digit Issuer Identification Number (ever changes from card token to card token), a 6-digit device identifier (the computer or mobile phone running the digital wallet), then use the 6-digit one-time passcode, a check digit generated from the first 18-digit with the Luhn algorithm.

Instead of a token being requested at the moment when the customer wants to redeem, per the standard RFC 6238 the token is automatically computed based on a shared secret between the cardholder wallet app and the issuer service. The secret is shared prior to redemption, for instance at the time the cardholder initially installs the cardholder wallet app or upon a successful authentication to the cardholder wallet app.

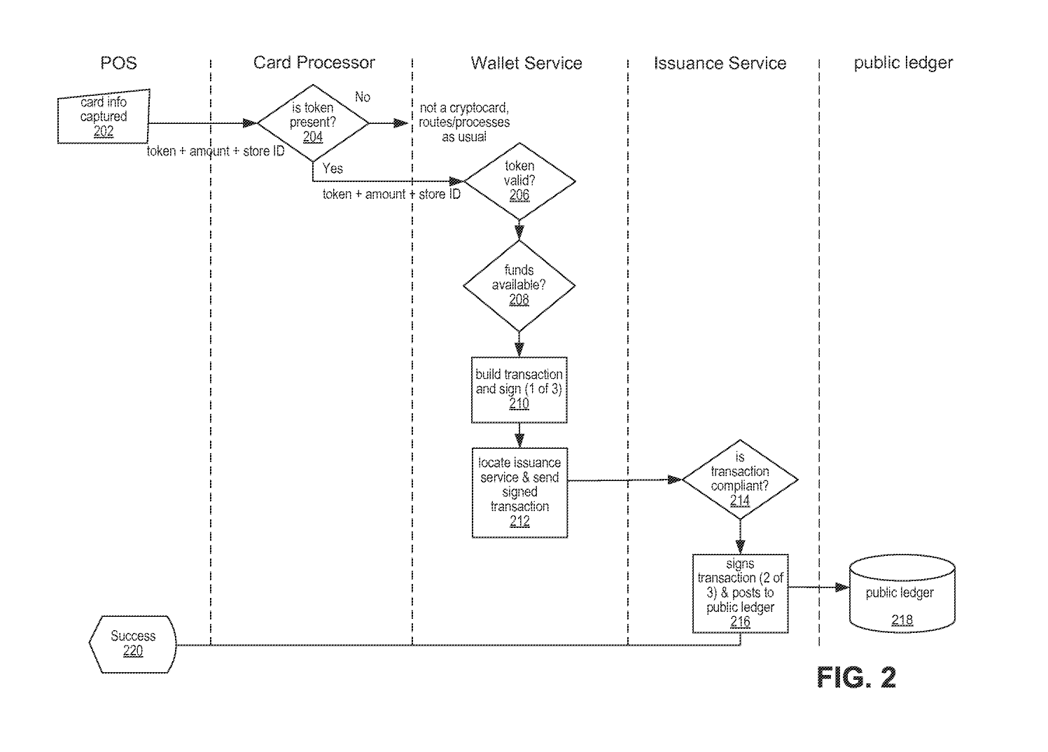

FIG. 2 is a time flow chart for transactions using merchant-issued currency, according to various embodiments. In step 202, upon presentation to the POS or online shopping cart and successful reading by the POS or online shopping cart of the card token, the card token goes through the merchant's payment system, and the merchant is able to detect that the card token is actually a token for a secure digital gift card because the card token starts with a specific 6-digit IIN (Issuer Identification Number, also called BIN) that the wallet service provider registered. In step 204, upon detection of the token, the merchant routes the requests to the wallet service provider server.

In step 206, the wallet service provider server validates the token. In step 208, the wallet service confirms that the cardholder has sufficient merchant issued credit for the purchase. In step 210, when the token is valid, assets are available at the token's corresponding address or addresses, and these assets are accepted by the merchant, then the wallet service prepares a public ledger transaction and signs it with the cardholder's private key. In step 212, the issuance service provider is then notified of the new transaction, and the issuance service provider validates the transaction's compliance with regulations and cardholder services. In step 214, the issuance service checks for compliance of the transaction. In step 216, assuming the transaction is compliant, the issuance service signs the transaction with its authorization key and in step 218, posts the transaction to the public ledger. Then, in step 220, the issuance service provides the wallet service provider a successful transaction ID, which is in turn provided to the point of sale.

In some embodiments of a method for using a digital wallet service, there are a number of entities that play a role. Entities include a digital wallet application and digital wallet service, a credit issuance service, and a merchant all of which, in combination, are configured to securely expend merchant-issued credit and encode transactions to a public ledger. In some embodiments, all of these entities are managed by the same organization. There is no express reason why these entities must be under a particular management organizational scheme.

The merchant uses the credit issuance service to issue a certain amount of merchant-issued credit to a digital wallet service in the name of a cardholder. The issuance is done through the issuance service who submits the transaction to the public ledger. The certain amount of merchant-issued credit makes up a balance. The digital wallet service obtains balance records from the issuance service or directly from the public ledger. The digital wallet service then enables the spending of the merchant-issued credit in a digital wallet through the digital wallet service and credit issuance service. In some embodiments, the credit issuance service and the merchant are the same entity. In other embodiments, the credit issuer and the merchant are separate entities and the credit issuer obtains merchant-issued credit from the merchant before issuing the merchant-issued credit to a user. Records of pre-purchased or issued merchant credit are stored in a shared decentralized database accessible by all parties through the Internet.

The digital wallet application generates a graphic user interface (GUI), which displays the digital wallet's content to the user and allows the user to select. The contents of the digital wallet, in this case, represent the digital gift card's value. When the user selects the digital wallet, the digital wallet application requests the digital wallet service to provide a fixed lifetime credit number which is usable to expend the certain amount of merchant-issued credits available on the selected card. The digital wallet application is supported by a web server or a database that communicates with a plurality of user devices associated with a plurality of users. Illustrative examples of user devices include smart phones, tablets, laptop computers, desktop computers, or “smart” wearable accessories.

In some embodiments, the issuing of the fixed lifetime credit code occurs periodically upon the end of the lifespan as long as the user maintains the request and is displaying the card on the digital wallet GUI. In some embodiments, the issuing of the fixed lifetime credit code occurs an additional time: when the user makes a second request, the fixed lifetime credit codes life is terminated and a second fixed lifetime credit code is issued.

In some embodiments, the issuance service establishes at least one tracking wallet, corresponding to the digital wallet, which stores cryptocurrency and is inaccessible to the user. An example of a cryptocurrency is Bitcoin, though other cryptocurrencies exist. A suitable cryptocurrency is one managed by a public ledger. An example of a public ledger is the blockchain, though others are suitable. When the cryptocurrency is Bitcoin, then the tracking wallet is managed and controlled by the Bitcoin protocol. Other cryptocurrencies are managed in other ways. In some embodiments, the cryptocurrency tracked by a public ledger is a custom designed currency. An example where use of a digital wallet and a corresponding tracking wallet are appropriate is when record of the digital wallet is held by a third party, such as the merchant.

In other embodiments, The issuance service creates a tracking wallet, which is synonymous with the digital wallet. Thus the only record of the existence of the merchant issued credit is the cryptocurrency tracking wallet. The cryptocurrency in the tracking wallet is used to generate transaction records which in turn encode data of transactions which are unrelated to the cryptocurrency contained within the tracking wallet. In these embodiments, the merchant and the issuance service make an agreement such that the merchant will honor the balance as encoded on the tracking wallet, and no further records are necessary.

In the single wallet embodiments, the gift card holder does not actually spend the cryptocurrency contained in the digital wallet/tracking wallet. Instead the cryptocurrency is used to generate transactions of either encoded amounts or encoded transactions that represent the expenditure of merchant issued credit.

The issuance service encodes the certain value of merchant-issued credit to the cryptocurrency tracked by a public ledger and associated with the tracking wallet. There are various embodiments of acceptable encoding. In some embodiments, a small amount of cryptocurrency called a dust amount is provided to the tracking wallet and data pertaining to merchant-issued credit is encoded to the transaction metadata through an encoding protocol. An example of an encoding protocol is the Open Assets Protocol, though other protocols are acceptable. In some embodiments, encoded data is generated by corresponding information to certain balances of the tracking wallet. As an example of an encoded amount, 0.00002500 of cryptocurrency might correspond to $25.

The issuance service generates a first encoded transaction associated with the tracking wallet(s), the first encoded transaction representing the balance of the certain amount of merchant-issued credit. In some embodiments, the transaction funds (e.g., dust amount, encoded amount) are sent from an issuance wallet to the tracking wallet. In addition to the dust amount, many cryptocurrencies additionally require a transaction fee.

In digital wallets that have multiple inputs and outputs, each kind of transaction associated with a given wallet has its own unique requirements for verification. Transaction fees have a low verification requirement because transaction fees only involve one entity: either the issuance service or the wallet service (depending on the transaction). Other transactions which include additional entities would include additional verification.

When the user wants to redeem the merchant-issued credit with the merchant, the user cites the fixed lifetime credit number in a transaction. The wallet service depletes the digital wallet of merchant-issued currency by the appropriate amount. This transaction creates a new balance of the merchant-issued credit.

In response to the user depleting the balance, multiple entities generate a second encoded transaction associated with the tracking wallet. In some embodiments, the multiple parties include the credit issuance service, the merchant and the wallet service. In order to verify the transaction to the necessary inputs and outputs of the tracking wallet, two of the entities sign the transaction. The second encoded transaction represents the new balance.

One of the entities retrieves encoded data from the public ledger concerning the tracking wallet. The encoded data includes the first encoded transaction and the second encoded transaction. Any of the above mentioned entities is enabled to retrieve the encoded data. The encoded transactions themselves are public as a result of being managed by the public ledger.

One of the entities decodes the encoded data. It is not mandatory that any given one of the entities decodes the data; any of the above mentioned entities is suitable to decode the encoded data. All that is required is a codec. The character of the codec depends on the method of encoding. In some embodiments, the codec is a data hash. In some embodiments, the codec is a mathematical formula. In various embodiments, the codec includes data regarding the correspondence of the tracking wallet and the digital wallet of merchant-issued currency. In various embodiments, the codec is made available to a number of entities to decode the data.

There are numerous uses for the decoded data. The decoded data provides a viewer with balance verification. The above mentioned entities, the user, and the merchant all have interests in the decoded data. There are applications for each to make use of the data. In one such use, the digital wallet application presents decoded data for the user in the graphic user interface.

The above method is illustrative, and many of the actions are performable by multiple parties. In such cases where it makes sense to do so, these actions can all be performed by a single entity or by many. In some embodiments, the merchant-issued credit is drawn from an inventory containing the merchant-issued credits from a plurality of merchants.

In some embodiments, encoded transaction verification is performed by a number of digital signatures. The transactions use any number of signatures, though three is a suitable example. The first digital signature is one of three digital signatures. In some embodiments, the first encoded transaction and second encoded transaction will not process without at least two of the three digital signatures. In some embodiments, the second digital signature is provided by the issuer of the merchant-issued credit.

Additional embodiments of an apparatus for encoding and subsequently decoding a digital wallet to a public ledger comprise a few components. An account server is enabled to create and manage a user account, the user account associated with but inaccessible to a user. A codec is enabled to generate an encoding scheme between merchant-issued credits and a cryptocurrency tracked by the public ledger. Embodiments of the encoding scheme include both encoded hash and encoded amounts. A transaction receiver is configured to receive notice that the user is transacting with the digital wallet associated with merchant-issued credit.

The transaction receiver is communicatively coupled to the account server. The transaction receiver is configured to forward a notice of a transaction with the digital wallet to the account server. The account server is configured to store with the user account an encoded hash received from the codec. The encoded hash is associated with a cryptocurrency transaction and comprises data associated with that transaction of the digital wallet.

The codec is configured to decode the encoded hash upon request by the account server. The account server is configured to output decoded data associated with the transaction of the digital wallet. In some embodiments, the account server is configured to output the decoded data to multiple entities. In some embodiments, the transaction receiver will not communicate the notice of the transaction to the account server until the transaction receiver has two or more authenticated notices of the transaction.

In some embodiments, the apparatus further includes a plurality of cryptocurrency wallets. The plurality of cryptocurrency wallets includes an issuing wallet, a user wallet, and a merchant wallet. The cryptocurrency transaction is configured to occur between the plurality of cryptocurrency wallets.

The cryptocurrency transaction is one of three types of transaction. First, an issuing transaction, wherein a dust amount of cryptocurrency is exchanged between the issuing wallet and the user wallet. Second, a spending transaction, wherein a dust amount of cryptocurrency is exchanged between the user wallet and the merchant wallet. Third, a minting transaction, wherein a dust amount of cryptocurrency is exchanged between the merchant wallet and the issuing wallet.

In some embodiments the cryptocurrency transaction includes a transaction fee. The transaction is drawn from yet another cryptocurrency wallet, a pool wallet, which is associated with no users.

In some embodiments, the apparatus further comprises a user interface. The user interface is communicatively coupled with the account server and configured to display the decoded data to the user. In some embodiments, the cryptocurrency tracked by a public ledger is bitcoins, and the public ledger is the blockchain. In other embodiments, the cryptocurrency tracked by a public ledger is a custom designed currency.

In some embodiments, users integrate legacy gift cards with static expenditure numbers. While the static expenditure number does not change, recording the gift card on the public ledger enables the user to have a record of transactions with the static expenditure number that are non-fraudulent. While the gift card potentially has fraudulent purchases, none of the fraudulent purchases will appear on the public ledger and the user is then enabled to prove to the merchant which transactions to void.

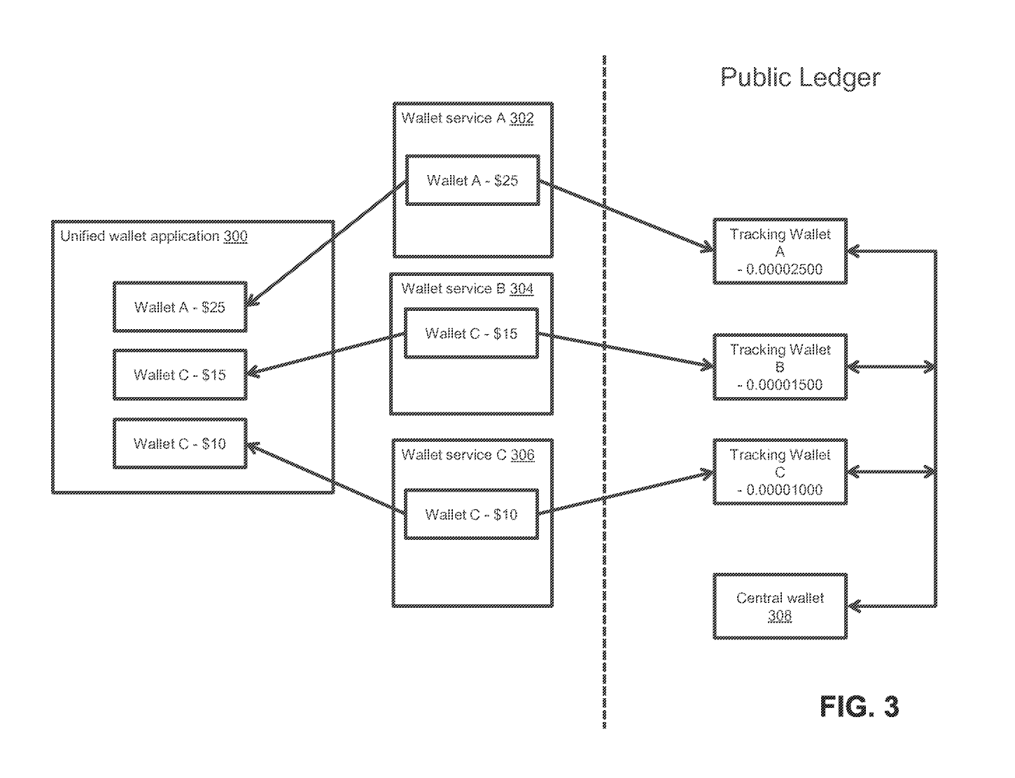

FIG. 3 is a block diagram illustrating a method for encoding wallets to a public ledger, according to various embodiments. In order to standardize a plurality of digital wallets, merchant-issued currencies are encoded onto public ledgers. The encoding is accomplished using the native capabilities of the public ledgers to issue custom currencies, if available, or as extensions leveraging the built-in extensibility capabilities of the public ledgers. Where custom currencies are not available, merchant-issued currency is represented in fractions of the currency of the public ledger (public currency).

In operation, a user first provides a unified application interface with necessary information to access one or more of the user's digital wallets (Wallets A, B, and C). The digital wallets could consist of a plurality of merchant-issued currencies (Merchants A, B, and C). Wallets A, B, and C are normally accessed through separate interfaces using merchant-specific applications or third-party applications. The unified application then inventories the user's digital wallets and presents all of the user's digital wallets, A-C, in a single user interface (unified wallet) wherein each individual digital wallet inside the unified wallet can be individually selected and have card tokens issued to the application interface. The user provides the card token to the POS as described above. The proper digital wallet is charged.

As an example wherein merchant currency is encoded to a public currency, a digital wallet would have $25.00 associated with Merchant A (Wallet A). Wallet A, could be on any number of online wallet services—Merchant A's personal service or a third-party service. Wallet A, with a $25 credit, is represented on the public ledger by 0.00002500 of the public currency. When Wallet A is brought into the unified wallet, there is an associated minting cost in acquiring the requisite public currency, thereby generating a public currency wallet. The user never has access to the public currency wallet. The public currency wallet is merely a representation of Wallet A, contained within the unified wallet. The public currency wallet is owned by the administrator of the unified application.

As Wallet A is spent or redeemed with Merchant A, the proper wallet service processes the expenditure. Additionally, the public currency digital wallet is emptied into a central wallet account owned by the administrator of the unified application. If $10 is redeemed from Wallet A, 0.00001000 from the public currency wallet is shifted into the central wallet. The transactions of the public currency are recorded on a public ledger.

As additional wallets from various wallet services are brought into the unified wallet, additional representative public currency wallets are created from the central wallet account. In this way, the public currency is reused repeatedly because the public currency only circulates between accounts owned by the administrator of the unified wallet.

To present a reliable user interface to the user, data is retrieved from the public ledger and decoded such that the data is presented so only merchant-issued currency is displayed to the user rather than public currency or public assets.

The embodiments disclosed in FIG. 3 concern when there are separate digital wallets for storing credit and for tracking the stored credit. In other embodiments where the tracking wallet provides the entire record, Wallet A-B do not exist. The entire center column of FIG. 3 is removed.

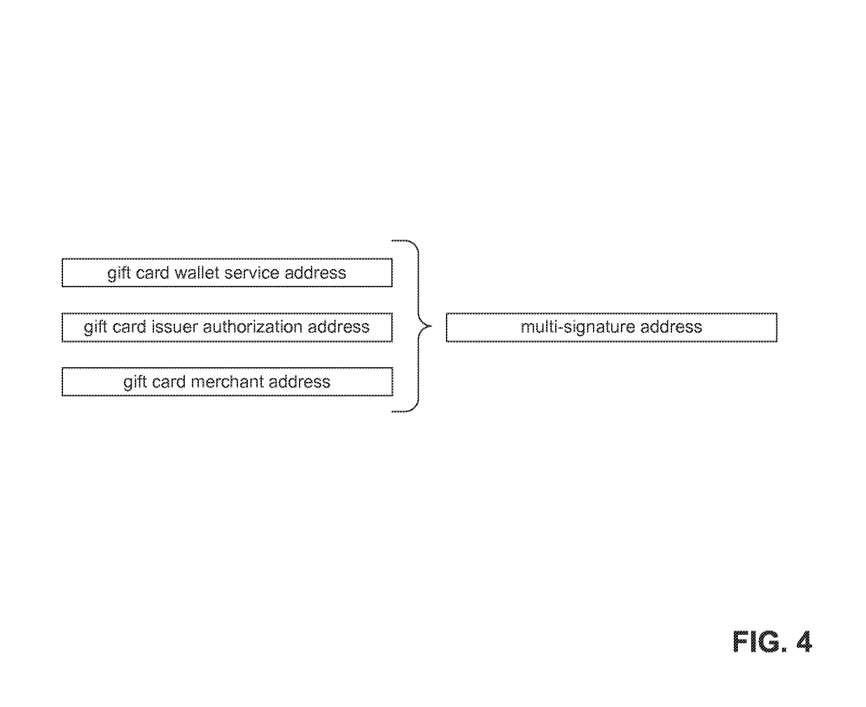

FIG. 4 is an embodiment of an authorization scheme, according to various embodiments. In order to ensure secure and compliant movement of funds, merchant-issued funds encoded as digital assets are stored in multi-signature addresses, a capability provided by the secure public ledger. Transactions transferring assets out of such addresses require multiple signatures. On secure public ledgers, multi-signature addresses are referred as N-of-M, meaning N out of the M possible signatures are required to authorize the transaction.

In some embodiments, the method uses 2-of-3 (N=2, M=3) addresses to secure and enforce compliance of digital gift cards. For each digital gift card on the secure ledger there is a distinct address holding the merchant-issued value. A 2-of-3 address is generated from 3 different addresses using an open source method available on secure public ledgers. Funds transferred out of the 2-of-3 address are only accepted by the secure public ledger if 2 of the 3 private keys of the respective 2 of the 3 addresses used to generate the 2-of-3 addresses are present. The invention teaches using 2-of-3 addresses controlled by the 3 parties to a gift card contract (the merchant, issuer, and cardholder) to secure and enforce compliance of digital gift cards. The present invention utilizes 2-of-3 addresses as follows:
One of the 3 addresses used is controlled by a private key belonging to the digital gift cardholder and held in the cardholder's wallet service.
One of the 3 addresses used is controlled by a private key belonging to the issuance service provider who ensures compliance with regulations.
One of the 3 addresses used is controlled by a private key belonging to the issuance merchant who ensures compliance with its own terms.

The transaction is authorized only if 2 of 3 signatures for these 3 addresses are present. The three possible signature combinations are as follows:
First, the gift card holder and the gift card issuance service both sign the transaction. This ensures that funds cannot move to any address, but only to a few addresses that the gift card issuance service provider authorizes.
Second, the gift card issuance services and the issuing merchant sign the transaction. This step ensures that funds can move from the address even if the cardholder does not authorize them and is necessary to ensure compliance with terms such as dormancy fees or expiration.
Third, the gift card holder and the issuing merchant sign the transaction.

This ensures that the merchant can accept funds that it issued without involving the issuance service.

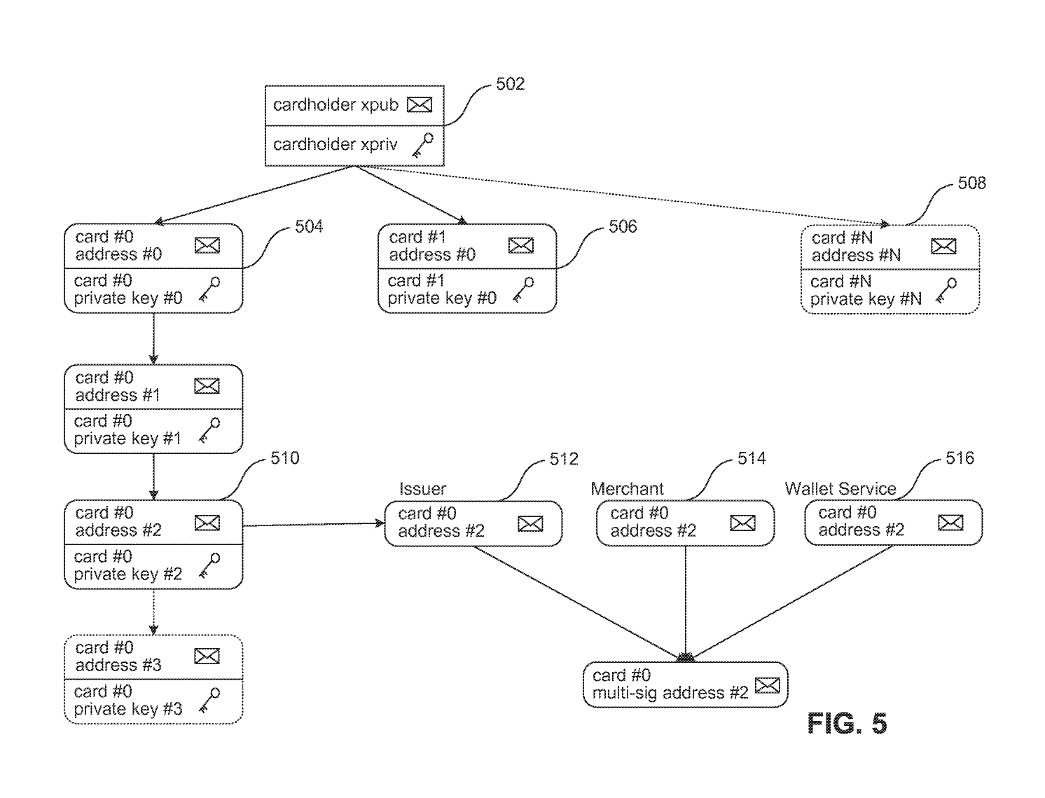

FIG. 5 is a derivation chart for public keys, according to various embodiments. At setup time, the cardholder wallet service, issuer service, and merchant securely share with each other a public key called an extended public key 502 which consists of a public key together with a key derivation code. Each party can use the extended public key 502 and derivation code as input to a standard key derivation algorithm documented in the Bitcoin Improvement Protocol specification 32 to derive additional public keys for any given path of the key derivation tree. Given a well-defined, agreed-upon key tree structure, it is possible for each party independently to generate additional 2-of-3 addresses that the other two parties can sign transactions from. All public keys of the cardholder in the tree can be derived by the issuer and merchant if they are given the extended public keys.

Displayed in FIG. 5, a holder of the extended public key 502 is enabled to generate the public address of any number of cards with any number of transactions. For example, there is card #0 and transaction #0 504, and card #1 and transaction #0 506, through to card #N and transaction #N 508. Further, given card #0 transaction #2 510 held by any of the entities, any other entity is enabled to derive the corresponding public address for the issuer 512, the merchant 514, or the wallet service 516.

When a card is not fully redeemed, to further enforce compliance and security, the unused portion of the card balance must be transferred to a new 2-of-3 address that is generated by a brand new set of 3 different addresses associated each with a private key respectively belonging to the cardholder, issuer, and merchant.

Each gift card is effectively a chain of multi-sig addresses that is tracked by the cardholder wallet app, the issuing service, and the merchant.

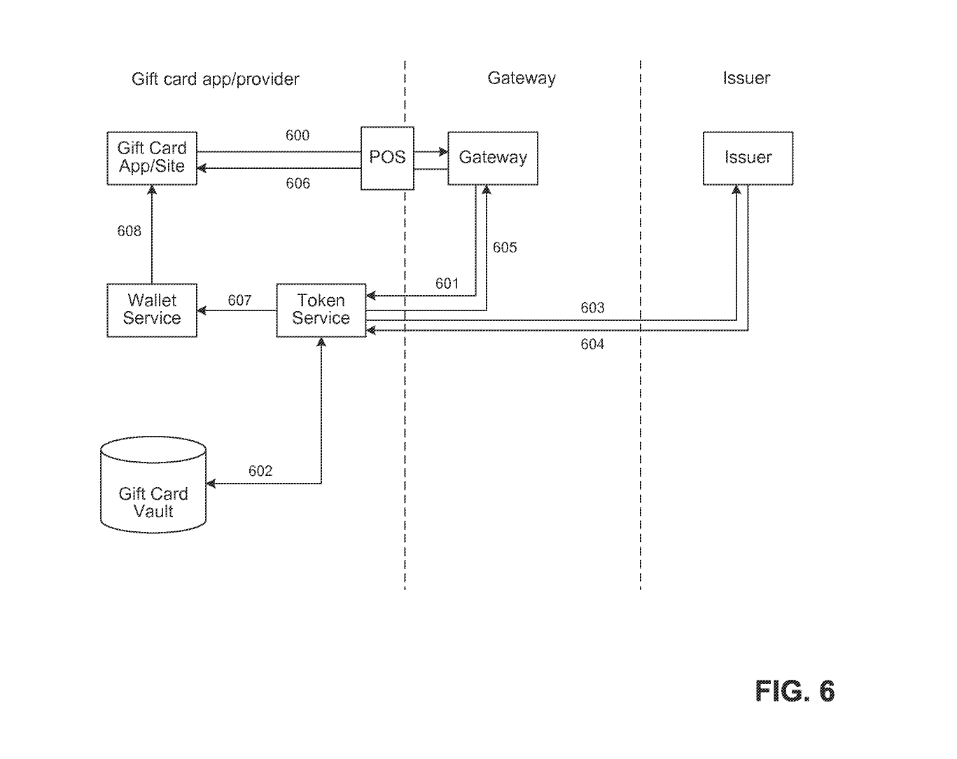

FIG. 6 is a block diagram flow chart of the redemption of tokenized existing gift cards, according to various embodiments. In step 600, at the point-of-sale in store, the issuer's employee scans the card off the mobile app. Alternatively, at the checkout of the issuer's online store, the customer types in the card number. The card token lifetime is such that the card can be typed in, scanned, and validated. As a result, the gateway receives the payment request together with the card token and payment context such as merchant and/or location identifier.

At step 601, per an established agreement between the issuer (merchant) and the gift card app/service provider, the gateway identifies the IIN as one owned by the gift card app/service provider and routes the request accordingly to the gift card/service. At step 602, the gift card app/service provider validates the token against data in its gift card vault. At step 603, if the token is valid, the payment request is updated with an actual card number and routed to the issuer's authorization server. At step 604, the issuer responds to the request.

At step 605, the token service at the gift card app/service provider relays the response to the gateway. At step 606, the gateway relays the response to merchant, and the employee notifies the customer of success or failure. At step 607, meanwhile, the token service relays the transaction processing result to the wallet service. At step 608, the wallet service relays transaction processing results to the gift card app/service.

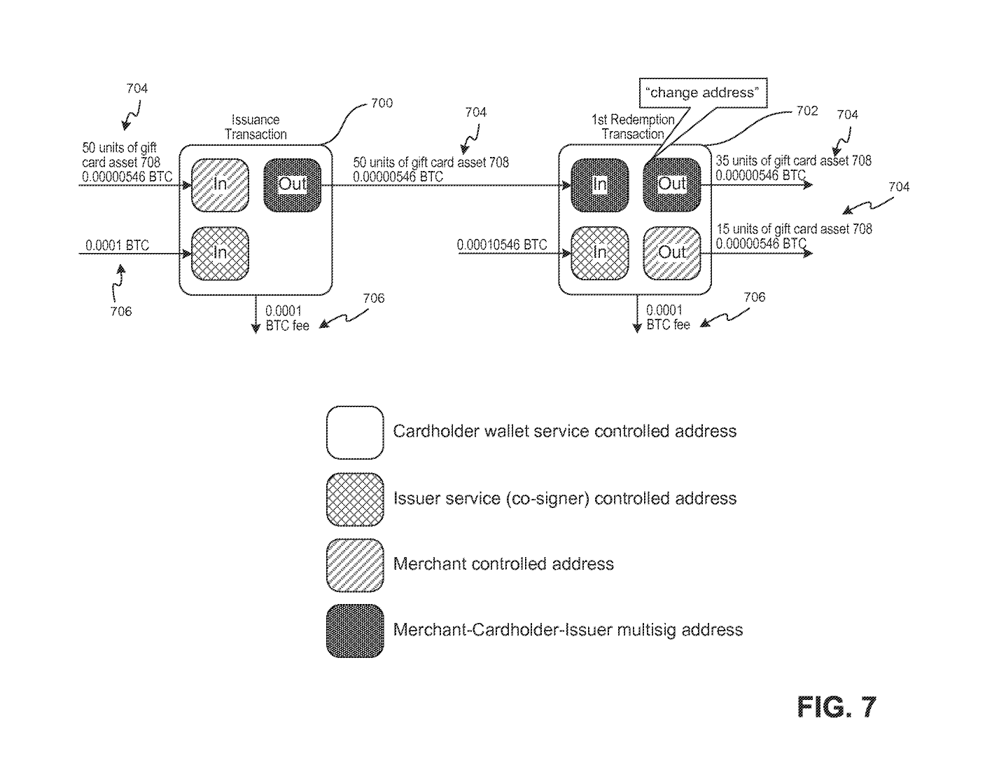

FIG. 7 is an example transaction diagram using dust amounts to encode data to a public ledger, according to various embodiments. FIG. 7 quotes specific amounts of Bitcoin. In practice it is not necessary that Bitcoin is used, nor the particular amounts quoted. FIG. 7 displays an issuance transaction 700 and a redemption transaction 702. At the time of filing, a “dust amount,” 704 or lowest amount of Bitcoin that one digital wallet is allowed to transfer to another is 0.00000546 BTC. The dust amount 704 is subject to change and varies. Further, transacting with Bitcoin carries transaction fees 706. Other cryptocurrencies vary with respect to transaction costs. Bitcoin requires payment to miners for “solving” a block of transactions. FIG. 7 represents the transaction fee as 0.0001 BTC. The transaction fee 706 is subject to change and varies.

In an example of a issuance transaction 700, there are multiple inputs a single output. The issuance transaction 700 refers to the creation of a gift card record on the public ledger (blockchain). At a first input 708, controlled by the merchant providing the credit, a dust amount 704 is supplied for use as an encoded transaction. The encoding contains the data concerning the gift card asset 710 (in FIG. 7, the gift card asset 710 comprises fifty units of credit for a merchant) is now associated with the user. At a second input 712, controlled by the issuance service, a transaction fee 706 is supplied. The output of the transaction is the multi-signature digital wallet associated with the user. This portion of the transaction is verified by two of: the wallet service, the merchant, and the issuance service. The single output 714 is the receiving end of the encoded dust amount 704. The issuance transaction 700 has an associated cost, so the transaction fee 706 is drawn out to finalize the transaction.

In an example of a redemption transaction 702, there are multiple inputs and outputs. The redemption transaction 702 refers to spending of part of the gift card asset 708. At a third input 716, the multi-signature digital wallet associated with the user provides a dust amount 704 for the transaction. Because there are multiple outputs, more than one dust amount is required. Thus, at a fourth input 718, controlled by the issuance service, a transaction fee 706 and an extra dust amount 704 is supplied. The data that the redemption transaction 702 actually contains is the spending of fifteen units of the gift asset 710. The remaining amount of gift asset 710 is then thirty-five units. This data is encoded into the redemption transaction 702.

The redemption transaction 702 includes multiple outputs. A first output 720 receives a dust amount 704 to show the “change” for the gift asset 710. The dust amount 704 associated with the first output 720 accordingly includes encoded data for the remaining of thirty-five units. The first output 720 is an digital wallet address controlled by multi-signature verification. In this example, a second digital wallet associated with the user and controlled by multi-signature verification is used. In this way, after every redemption transaction 702, the digital wallet associated with the user changes address. Accordingly, the third input 716 and the first output 720 are to different digital wallet addresses, despite that the same verification is required. In some embodiments, the digital wallet associated with the user remains the same, thus the third input 716 and the first output 720 are the same address.

A second output 722, controlled by the merchant who originally provided the credit also receives a dust amount 704. The dust amount 704 associated with the second output 722 includes encoded data for the expenditure of fifteen units. The digital wallet address used in the second output 722 is the same as the first input 708. In this way, the dust amounts 704 are recycled. The redemption transaction 702 has an associated cost, so the transaction fee 706 is drawn out to finalize the transaction.

The example in FIG. 7 is merely illustrative and various embodiments include variations on the ownership and required verification for each of the digital wallet addresses associated with the public ledger encoding of the gift card asset 710. All of the amounts referenced are illustrative.

I/We claim:

1. A method for using a digital wallet service, a digital wallet application, and a credit issuer, configured to securely expend merchant-issued credit and encode transactions to a public ledger, comprising:
issuing a certain amount of merchant-issued credit by the credit issuer in the name of a user, managed by the wallet service, the certain amount of merchant-issued credit comprising a balance;
enabling the spending of merchant-issued credit through the digital wallet service and credit issuer;
generating, by the digital wallet application, the GUI displaying a digital representation of certain amount of merchant-issued credit to the user and allowing the user to select the digital representation, wherein selecting the digital representation directs the digital wallet service to provide a fixed lifetime credit number which is usable to expend the certain amount of merchant-issued credit;
encoding the certain value of merchant-issued credit to a cryptocurrency tracked by a public ledger;
establishing, by either the digital wallet service or the credit issuer, at least one tracking wallet containing cryptocurrency, the at least one tracking wallet corresponding to the balance of the certain amount of merchant issued credit and the cryptocurrency in the at least one tracking wallet does not comprise the balance of the merchant issued credit;
generating a first encoded transaction associated with the at least one tracking wallet, the first encoded transaction representing the balance of the certain amount of merchant-issued credit;
depleting the balance of the certain amount of merchant-issued credit using the fixed lifetime credit number in a transaction, thereby creating a new balance;
generating a second encoded transaction associated with the tracking wallet, the second encoded transaction representing the new balance;
retrieving encoded data from the public ledger concerning the tracking wallet, the encoded data including the first encoded transaction and the second encoded transaction;
decoding the encoded data, thereby generating decoded data; and
presenting the decoded data for the user in the graphic user interface.

2. A method for operating a digital wallet service, comprising:
enabling, by a web server, the expending of a balance associated with merchant-issued credit in through a digital wallet service;
issuing, by a web server, a fixed lifetime credit code upon request by a user, wherein during the lifespan of the fixed lifetime credit code the user is allowed to use the fixed lifetime credit code to expend the balance;
corresponding, by the web server, at least one tracking wallet to the balance, the at least one tracking wallet maintained by at least one public ledger database and corresponding to a cryptocurrency tracked by a public ledger;
providing, by the web server, at least a first digital signature for a first encoded transaction associated with the at least one tracking wallet, the first encoded transaction containing data representing the balance;
receiving, at the web server, transaction requests referencing the fixed lifetime credit number;
authenticating, by the web server, the transaction request to deplete the balance by a fixed amount, thereby generating a new balance; and
providing, by the web server, at least a first digital signature for a second encoded transaction associated with the at least one tracking wallet, the second encoded transaction containing data representing the new balance.

3. The method of claim 2, further comprising:
issuing the merchant-issued credit to the user.

4. The method of claim 3, wherein said issuing of the merchant-issued credit is drawn from an inventory containing the merchant-issued credits from a plurality of merchants.

5. The method of claim 2, wherein said issuing of the fixed lifetime credit code occurs periodically upon the end of the lifespan as long as the user maintains the request.

6. The method of claim 2, wherein said issuing of the fixed lifetime credit code occurs an additional time if the user makes a second request, wherein upon the second request, the fixed lifetime credit code's lifespan is terminated and a second fixed lifetime credit code is issued.

7. The method of claim 2, wherein the cryptocurrency tracked by a public ledger is a custom designed currency.

8. The method of claim 2, wherein the first digital signature is one of three digital signatures, and the first encoded transaction and second encoded transaction will not process without at least two of the three digital signatures.

9. The method of claim 8, wherein the second digital signature is provided by the issuer of the merchant-issued credit.

10. A method for operating a digital wallet application, comprising:
generating a graphic user interface (GUI) on a user device, the GUI displaying one or more digital wallets to a user and enabling the user to select the digital wallets, the digital wallets each having a balance associated with merchant-issued credit, wherein selecting a first digital wallet sends a request to a digital wallet service to provide a fixed lifetime credit number which is usable to expend some or all of the balance of merchant-issued credit corresponding to the first digital wallet;
receiving a fixed lifetime credit number and displaying the fixed lifetime credit number to a user on the graphic user interface, the fixed lifetime credit number has an associated lifespan;
retrieving encoded data from a public ledger, where the encoded data on the public ledger corresponds to the balance for the digital wallets;
decoding the encoded data; and
presenting decoded data as the balance of merchant-issued credit for the digital wallets for the user in the graphic user interface.

11. The method of claim 10, wherein said receiving a fixed lifetime credit code occurs periodically upon the end of the lifespan as long as the digital wallet remains selected.

12. The method of claim 10, further comprising:
requesting a new fixed lifetime credit code during the lifespan of the fixed lifetime credit code, wherein receiving the new fixed lifetime credit code prematurely ends the lifespan of the fixed lifetime credit code.

13. The method of claim 10, wherein the digital wallet is tracked by the public ledger.

14. An apparatus for encoding and subsequently decoding a digital wallet to a public ledger, comprising:
an account server, the account server enabled to create and manage a user account, the user account associated with, but inaccessible to a user;
a codec enabled to generate an encoding scheme between merchant-issued credits and a cryptocurrency tracked by the public ledger;
a transaction receiver configured to receive notice that the user is transacting with the merchant-issued credit;
wherein the transaction receiver is communicatively coupled to the account server, and is configured to forward notice of a transaction with the digital wallet to the account server, and the account server is configured to store with the user account an encoded hash, received from the codec, the encoded hash associated with a cryptocurrency transaction and comprising data associated with the transaction of the digital wallet; and
wherein the codec is configured to decode the encoded hash upon request by the account server and the account server is configured to output decoded data associated with the transaction of the digital wallet.

15. The apparatus of claim 14, wherein the account server is configured to output the decoded data to multiple entities.

16. The system of claim 14, wherein the transaction receiver will not communicate the notice of the transaction to the account server until the transaction receiver has two or more authenticated notices of the transaction.

17. The system of claim 14, further comprising:
a plurality of cryptocurrency wallet addresses, including an issuing wallet, a user wallet, and a merchant wallet, wherein the cryptocurrency transaction is configured to occur between the plurality of cryptocurrency wallets; and
wherein cryptocurrency transaction is one of:
an issuing transaction, wherein a dust amount of cryptocurrency is exchanged between the issuing wallet and the user wallet;
a spending transaction, wherein a dust amount of cryptocurrency is exchanged between the user wallet and the merchant wallet; or
a minting transaction, wherein a dust amount of cryptocurrency is exchanged between the merchant wallet and the issuing wallet.

18. The system of claim 14, further comprising:
a user interface, the user interface communicatively coupled with the account server and configured to display the decoded data to the user.

19. The system of claim 14, wherein the cryptocurrency tracked by a public ledger is bitcoins, and the public ledger is the blockchain.

20. The system of claim 14, wherein the cryptocurrency tracked by a public ledger is a custom designed currency.

21. The system of claim 17, wherein the cryptocurrency transaction additionally comprises a transaction fee, the transaction fee drawn from a pool wallet associated with no user.
